(19) United States
(12) Patent Application Publication
(10) Pub. No.: US 2002/0077793 A1
(43) Pub. Date: Jun. 20, 2002

(54) System and method for automatically determining an overall risk resulting from a plurality of independent risk factors

(76) Inventor: Andreas Poncet, Zuerich (CH)

Correspondence Address: Robert S. Swecker, BURNS, DOANE, SWECKER & MATHIS, L.L.P., P.O. Box 1404, Alexandria, VA, 22313-1404, US

(21) Appl. No.: 09/978,687

(22) Filed: Oct. 18, 2001

(30) Foreign Application Priority Data
Oct. 18, 2000 (EP) 00810963.9

(51) Int. Cl. G06F 17/10

(52) U.S. Cl. 703/2

(57) ABSTRACT

Method and system (1) for automatically determining an overall risk resulting from a plurality of independent risk factors, in which method and system a fast Fourier transform (FFT) is calculated with the aid of an FFT processor module (4) in each case for an accepted probability density function of an independent risk factor, in which method and system the transformed probability density functions of the independent risk factors are multiplied by one another by means of a multiplication module (5), and in which method and system an IFFT processor module (6) is used to calculate a probability density function proportional to the probability density function of the overall risk by calculating an inverse FFT transform for the product calculated by the multiplication module (5). Probability density functions are preferably respectively represented by a probability density vector, the vector elements of a probability density vector respectively corresponding to equidistant samples of the relevant probability density function.

### DESCRIPTION

### TECHNICAL FIELD

The present invention relates to a system and a method for automatically determining an overall risk resulting from a plurality of independent risk factors. In particular, the present invention relates to a system and a method for automatically determining an overall risk resulting from a plurality of independent risk factors in accordance with the preamble of the independent system claim and, respectively, in accordance with the preamble of the independent method claim.

### PRIOR ART

Particularly during the last decade, there has been a continuous increase in the number and the size of assets of companies and organizations, resulting also in a corresponding increase in potential instances of damage and financial losses, as has been demonstrated dramatically by various environmental events as well as events of an economic, political and technical nature.

Risk assessments are becoming more and more important even outside the fields of finance and insurance. Also contributing to this are intensifying globalization and technology which develops and spreads evermore quickly, and these lead to a higher level of international dependencies and an increase in the complexity of technological connections. An important part of risk management is quantitative risk analysis based on efficient mathematical methods. In this case, the problem consists particularly in estimating an overall risk resulting from a combination of a plurality of independent risk factors in order to provide an optimum safeguard against possible losses.

When consideration is given to a number of independent risk factors respectively corresponding to a possible individual loss which is caused by an environmental event which occurs or an event of an economic, political or technical nature, possible overall loss is yielded from the sum of these possible individual losses. In order to estimate the overall risk being posed, a calculation is made, for example, of the probability that the overall loss does not exceed a specific value. Even if an average value of an overall loss can be calculated simply by adding the average values of the individual losses, this does not apply for the corresponding probability density functions (probability distributions), since these cannot be added.

A plurality of automated (computer-based) systems for estimating risk are currently available for estimating the overall risk resulting from a plurality of independent risk factors. These conventional systems for risk estimation use what is called the Monte Carlo simulation method to calculate the overall risk.

The Monte Carlo simulation method is a stochastic and iterative method in which a large number of scenarios are calculated, a set of risk factors being determined for each of the scenarios by a random process. This random process is executed in such a way that the individual probability distributions (probability density functions) of the risk factors are considered. The value of the overall loss is calculated and stored for each of the scenarios by summing the individual losses. Subsequently, a histogram is produced from the ordered results of the simulated scenarios as an approximation to the unknown probability distribution of the overall risk.

However, systems based on the Monte Carlo simulation method have various disadvantages. A first disadvantage of the systems based on Monte Carlo is that in practice the risk factors do not simply correspond to classic distribution models such as, for example, a Gaussian, exponential or Poisson distribution, and the matching of a random number generator to specific probability distributions (probability density functions) not analytically defined is typically very demanding computationally and therefore time-consuming and expensive.

A further disadvantage of the systems based on Monte Carlo is that it is typically necessary to calculate a very large number of scenarios before the convergence of the histogram to the unknown probability distribution can be accepted as adequate. In fact, the accuracy improves only very slowly: to improve the accuracy by the factor f, for example ten, the number of iterations, that is to say the number of scenarios, must be increased by the factor f², that is to say the factor one hundred in the present example.

Finally, a substantial disadvantage of the systems based on Monte Carlo is that their accuracy is worsened for dramatic events, in particular, that is to say events of low probability. This means, consequently, that substantially more additional iterations are required again in systems based on Monte Carlo for satisfactorily accurate simulation of rare but important events, and this leads to a further increase in the computing demands, the outlay on time and thus the costs.

### SUMMARY OF THE INVENTION

It is an object of the present invention to propose a novel and better system and a novel and better method for automatically determining an overall risk resulting from a plurality of independent risk factors which, in particular, do not have the disadvantages of the prior art.

In accordance with the present invention, these objects are achieved, in particular, by the elements of the independent claims. Further advantageous embodiments follow, in addition, from the dependent claims and the description.

These objects are achieved by the present invention particularly by virtue of the fact that an FFT processor module is used to calculate a fast Fourier transform (FFT) respectively for an accepted probability density function (probability distribution) of an independent risk factor, that the transformed probability density functions of the independent risk factors are multiplied by one another by means of a multiplication module, and that an IFFT processor module (inverse fast Fourier transformation) is used to calculate a probability density function proportional to the probability density function of the overall risk by calculating an inverse FFT transform for the product calculated by the multiplication module. The advantage of this solution for automatically determining an overall risk resulting from a plurality of independent risk factors consists, in particular, in that it is not iterative, and so the accuracy of the result is not a function of the number of iterations. A further advantage of the solution proposed here consists in that no use is made of complicated random processes which are matched in a computationally demanding way to probability density functions (probability distributions) not analytically defined, but that the determination of the overall risk resulting from a plurality of independent risk factors is based on a direct calculation from the individual probability density functions of the independent risk factors. Finally, the proposed solution for automatically determining an overall risk resulting from a plurality of independent risk factors has the advantage that it can be executed with the aid of conventional FFT processor modules which are known, in particular, from the field of digital signal processing. This also holds for the IFFT processor module, since IFFT processor modules have the same structure as FFT processor modules as regards operators and operand registers.

In a preferred design variant, the probability density functions are respectively represented in the system for executing the method proposed here by a probability density vector, the vector elements of a probability density vector respectively corresponding to equidistant samples of the relevant probability density function. In this preferred design variant, an FFT length optimization module is used to calculate the sum of the vector lengths of the probability density vectors of the independent risk factors, the value of the smallest power of two is determined which is greater than this calculated sum, and the vector length of the probability density vectors of the independent risk factors is increased to this value of the power of two, additional vector elements with the value zero being added (to the probability density vectors). The advantage of lengthening the probability density vectors to the said length consists, in particular, in that, firstly, it is possible to avoid the known aliasing problems in the field of digital signal processing and, secondly, that a particularly fast FFT algorithm, for example Radix 2, can be used for FFT lengths with a power of two.

### BRIEF DESCRIPTION OF THE DRAWINGS

A design of the present invention is described below with the aid of an example. The example of the design is illustrated by the following single attached figure:

FIG. 1 shows a block diagram which illustrates schematically a system for automatically determining an overall risk resulting from a plurality of independent risk factors, which system comprises an input interface module, an FFT length optimization module, a plurality of FFT processor modules, a multiplication module, an IFFT processor module, a scaling module, an integration module, a display module and an output module.

### WAYS OF IMPLEMENTING THE INVENTION

Starting from a simple case with two independent risk factors X, Z, from which the general case with n independent risk factors can be derived, it is demonstrated in the next sections that the fast Fourier transformation (FFT) can be used to determine overall risks resulting from a plurality of independent risk factors, respectively the FFT processor modules for calculating the probability distribution (probability density functions) of an overall risk resulting from a plurality of independent risk factors.

It may be assumed that the risk factors X, Z are sampled with a finite resolution Δ, that is to say the risk factors X and Z can assume the values 0, Δ, 2Δ, 3Δ, . . .

In addition, probabilities αₖ and βₖ may be defined for the values k=0, 1, 2, . . . such that:

P(X=kΔ)=αₖ

P(Z=kΔ)=βₖ

Let the probability be:

γₖ\hat{=}P(Y=kΔ)

for the overall loss Y=X+Z resulting from the risk factors X and Z.

Because of the independence of the risk factors X and Z, it holds that:

$${γ}_{k} = P ( X + Z = k Δ ) = {\sum }_{l} P ( X = l Δ ) P ( Z = ( k - l ) Δ \vert X = l Δ )$$

$${γ}_{k} = {\sum }_{l} P ( X = l Δ ) P ( Z = ( k - l ) Δ ) = {\sum }_{l} {α}_{l} {β}_{k - l}$$

It follows for the N-point fast Fourier transform (FFT) of the sequence γ₀, . . . , γ_{N-1} that:

$$FFT = \{ {γ}_{k} \} ( n ) = {\sum }_{k} {γ}_{k} {ⅇ}^{- j2π n k / N} = {\sum }_{k} {\sum }_{l} {α}_{l} {β}_{k - l} {ⅇ}^{- j2π n k / N} = {\sum }_{k} {\sum }_{l} {α}_{l} {ⅇ}^{- j2π n l / N} {β}_{k - l} {ⅇ}^{- j2π n ( k - l ) / N} = ( {\sum }_{l} {α}_{l} {ⅇ}^{- j2π n l / N} ) ( {\sum }_{k} {β}_{k} {ⅇ}^{- j2π n k / N} ) = FFT \{ {α}_{l} \} ( n ) FFT \{ {β}_{k} \} ( n ) .$$

It follows from this for the calculation of the probability that:

γₖ=IFFT{FFT{αₗ}(n)FFT{βₖ}(n)},

IFFT being the inverse fast Fourier transform. Because γₖ≡p_{γ}(kΔ)Δ, the obtained sequence S_{γ}=γ₀/Δ, . . . , γ_{N-1}/Δ corresponds to the discrete probability density function of the overall risk resulting from the independent risk factors.

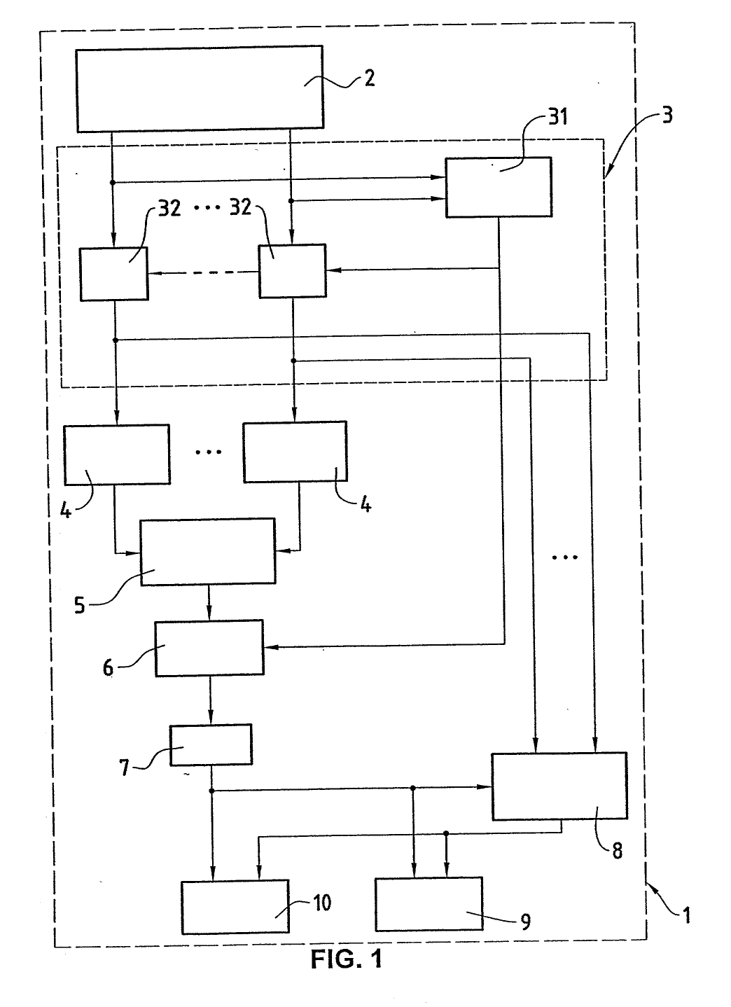

In FIG. 1, the reference 1 relates to the system for determining overall risks resulting from a plurality of independent risk factors, which system 1 calculates the discrete probability density function S_{Y} of the overall risk resulting from the independent risk factors, as shown above by means of FFT and IFFT. As illustrated in FIG. 1, system 1 comprises a plurality of modules 2 to 10 which, for example, are implemented as programmed software modules on a common computer or on a plurality of interconnected computers which respectively comprise one or more processors. The programmed software modules are stored, for example, as computer program code on a computer-readable medium. As explained explicitly in part in the following sections, it is also possible to implement at least some of the modules 2 to 10 partially or completely, individually or combined with one another by means of hardware, and/or to use special processors, for example signal processing processors, at least for certain modules.

The system 1 has an input interface module 2 for accepting probability density functions (probability distributions) for each independent risk factor which is to be considered in determining the overall risk. The input interface module 2 comprises, for example, a module for holding data media, a data terminal for data input or a data communications interface for data exchange. The probability distributions of the independent risk factors are respectively represented in the system 1 as probability density vectors Rₙ, the vector elements rₙ₁, . . . , rₙₘ of a probability density vector Rₙ respectively corresponding to m equidistant samples of the relevant probability density function. The probability density vectors Rₙ of the independent risk factors are either transferred directly to the input interface module 2, or they are generated in the input interface module 2 (by sampling) from the probability density function of the relevant independent risk factors.

The probability density vectors Rₙ of the independent risk factors are transferred by the input interface module 2 to the FFT length optimization module 3. An FFT length calculation module 31 of the FFT length optimization module 3 is used to calculate the sum L of all the vector lengths 1ₙ of the probability density vectors Rₙ of the independent risk factors, and the value of the smallest power of two k=2^{p} is determined which is greater than the calculated sum L. One or more vector lengthening modules 32 of the FFT length optimization module 3 are used to increase the vector lengths of each of the probability density vectors Rₙ of the independent risk factors to this value of the power of two k=2^{p}, additional vector elements rₙₘ₊₁ . . . rₙₖ with the value zero being added (zero padding).

The FFT length optimization module 3 respectively feeds the lengthened probability density vectors Rₙ of the independent risk factors in a sequential fashion to an FFT processor module 4 or, preferably, in parallel to a plurality of FFT processor modules 4. The FFT processor modules 4 can respectively be designed as specific hardware circuits, which are integrated (in a chip) for example, or they can be implemented as programmed software modules on a specific signal processing processor, or they can be implemented as programmed software modules on a processor of a conventional computer. The FFT processor module 4 is used respectively to calculate fast Fourier transforms for the probability density vectors Rₙ of the independent risk factors, and to buffer the resulting transformed vectors, which comprise complex values, in a sequential design of the FFT processor modules 4, or to clock them forward to the next downstream module 5 in a parallel design of a plurality of FFT processor modules 4. The FFT processor modules 4 can be designed on the basis of particularly fast FFT algorithms, for example Radix 2, on the basis of the preceding lengthening of the probability density vectors Rₙ of the independent risk factors to a power of two k=2^{p}.

The FFT-transformed probability density vectors of the independent risk factors are fed to the multiplication module 5 directly or via buffers (for example registers). The multiplication module 5 can be implemented as a specific hardware circuit, for example integrated, for example together with the FFT processor modules 4, or it can be implemented as a programmed software module on a conventional processor. The multiplication module 5 is used for elementwise multiplication of the FFT-transformed probability density vectors of the independent risk factors, the result being a vector whose elements correspond to the elementwise multiplication of the corresponding elements of the transformed probability density vectors (for example, the elementwise multiplication of a vector U, having the elements u₁ and u₂, by a vector V, having the elements v₁ and v₂, yields the vector W having the elements u₁v₁ and u₂v₂).

The vector resulting from the multiplication module 5 is fed by the multiplication module 5 to the IFFT processor module 6 which then executes an inverse fast Fourier transformation. The IFFT processor module 6 has the same structure as regards operators and operand registers as the FFT processor modules 4, and can therefore be designed as described above for the FFT processor modules 4. The elements of the inversely-transformed vector resulting from the IFFT processor module 6 are proportional to the values of the discrete probability density function S_{Y}, derived above, of the overall risk resulting from the independent risk factors, and are appropriately scaled in the scaling module 7. In an equidistant sampling of the independent risk factors or the probability density functions assigned to these independent risk factors, with the aid of the finite resolution Δ (as specified above), the scaling factor of the scaling module 7 has the value Δⁿ⁻¹, “n” referring to the number of independent risk factors. The elements of the probability density vector R_{Y} resulting from the scaling module 7 correspond to the values of the discrete probability density function S_{Y}, derived above, of the overall risk resulting from the independent risk factors.

As illustrated in FIG. 1, the probability density vector R_{Y} of the overall risk resulting from the independent risk factors, as well as the probability density vectors R₁ to Rₙ can be fed to the integration module 8 for evaluation. The integration module 8 respectively calculates for the probability density vectors “integrated” vectors whose elements are respectively calculated from the cumulative sum of the elements of the relevant probability density vector (for example, the integration of a vector V having the elements v₁, v₂ and V₃ by the integration module 8 yields the resulting vector Vi having the elements v₁, v₁+v₂ and v₁+v₂+v₃) The integration module 8 therefore calculates the percentiles, yielded from the probability density vectors, which can be used to estimate loss values for given probabilities. The “integrated” probability density vector R_{y} of the overall risk resulting from the independent risk factors can be used to determine the possible overall loss for a given probability, the value of the possible overall loss being yielded by adding the individual losses determined by the independent risk factors. The “integrated” probability density vectors R₁ to Rₙ can be used to determine the influence of individual risk factors on a possible overall loss for a given probability. In this case, it is possible to determine for a given probability that element (or the index of that element) of the “integrated” probability density vector which is equal, or comes closest to the desired probability (for example for a risk factor r with the possible loss values “a”, “b”, “c”, “d” and “e”, the associated probability density vector V having the elements 0.2, 0.4, 0.3, 0.05 and 0.05, as well as the associated “integrated” probability density vector Vi having the elements 0.2, 0.6, 0.9, 0.95 and 1.0 for a given probability of 95%, the fourth element “0.95” of the “integrated” probability density vector is yielded as the closest element, and thus the fourth possible loss value “d” of the risk factor r is yielded as the quantile under search, that is to say in accordance with the risk factor r a loss value of not greater than “d” is yielded with a 95% probability).

As illustrated in FIG. 1, the system 1 also comprises a display module 9, with the aid of which the specific results are displayed on a screen and/or printed out for a user of the system 1, for example in graphical and/or numerical form. The display module 9 displays, for example, the calculated probability density vector R_{y} of the overall risk resulting from the independent risk factors, the “integrated” probability density vectors R₁ to Rₙ and R_{Y} as well as the influences of the individual independent risk factors on the overall risk. In particular, when it is necessary to consider numerous independent risk factors, the influences of the individual independent risk factors on the overall risk can be determined, for example, by an evaluation module (not illustrated) of the system 1, for example a programmed software module, and, for the purpose of a better overview for the user of the system 1, can be sorted in accordance with the proportion of their influence, for example. The output module 10 can be used, in addition, to pass on the specific results of the system 1 to units outside the system 1. The output module 10 comprises, for example, a module for holding data media or a data communications interface for data exchange.

The proposed system and method for automatically determining an overall risk resulting from a plurality of independent risk factors can also be used, for example, as a tool for decision support, in particular for real-time decision support, in which case, in addition to financial and energy markets (for example for trade in these fields), mention should also be made, for example, of complex technical systems, for example systems in information technology and/or telecommunications, or power plant systems, as fields of application.

### List of Reference Numerals

1 System

2 Input interface module

3 FFT length optimization module

4 FFT processor module

5 Multiplication module

6 IFFT processor module

7 Scaling module

8 Integration module

9 Display module

10 Output module

31 FFT length calculation module

32 Vector lengthening module

1. A system (1) for automatically determining an overall risk resulting from a plurality of independent risk factors, which system (1) comprises an input interface module (2) for accepting probability density functions which are respectively assigned to one of the independent risk factors, characterized
in that the system (1) comprises at least one FFT processor module (4), which is set up such that it calculates an FFT transform for an accepted probability density function of an independent risk factor,
in that the system (1) comprises a multiplication module (5) which is set up such that it multiplies by one another the transformed probability density functions of the independent risk factors, and in that the system (1) comprises an IFFT processor module (6) which is set up such that it calculates a probability density function proportional to the probability density function of the overall risk by calculating an inverse FFT transform for the product calculated by the multiplication module (5).

2. The system (1) as claimed in claim 1, characterized in that it is set up such that probability density functions are represented in the system (1) in each case by a probability density vector, the vector elements of a probability density vector respectively corresponding to equidistant samples of the relevant probability density functions, in that the FFT processor module (4) is set up such that it represents the result of the FFT transformation of a probability density vector in the system (1) as a vector in each case, and in that the multiplication module (5) is set up such that it represents the calculated product in the system (1) as a vector whose vector elements are calculated by elementwise multiplication of the transformed probability density vectors.

3. The system (1) as claimed in claim 2, characterized in that it comprises an FFT length optimization module (3) which is set up such that it calculates the sum of the vector lengths of the probability density vectors of the independent risk factors, in that it determines the value of the smallest power of two which is greater than the calculated sum, and in that it increases the vector length of the probability density vectors of the independent risk factors to this value of the power of two, additional vector elements with the value zero being added.

4. The system (1) as claimed in one of claims 2 or 3, characterized in that it comprises a scaling module (7) which is set up such that it scales the probability density functions proportional to the probability density function of the overall risk with the aid of a value which is based on the equidistance with which the probability density vectors were determined by sampling from the probability density functions of the independent risk factors.

5. The system (1) as claimed in one of claims 1 to 4, characterized in that the IFFT processor module (6) has the same structure as the FFT processor module (4) as regards operators and operand registers.

6. A method for automatically determining an overall risk resulting from a plurality of independent risk factors, in which method an input interface module (2) is used to accept probability density functions which are assigned in each case to one of the independent risk factors, characterized in that an FFT transform is calculated in each case by means of an FFT processor module (4) for an accepted probability density function of an independent risk factor,
in that the transformed probability density functions of the independent risk factors are multiplied by one another by means of a multiplication module (5), and
in that an IFFT processor module (6) is used to calculate a probability density function proportional to the probability density function of the overall risk by calculating an inverse FFT transform for the product calculated by the multiplication module (5).

7. The method as claimed in claim 6, characterized in that probability density functions are respectively represented by a probability density vector, the vector elements of a probability density vector respectively corresponding to equidistant samples of the relevant probability density function, in that the result of the FFT transformation of a probability density vector by the FFT processor module (4) is respectively represented as a vector, and in that the calculated product is represented by the multiplication module (5) as a vector whose vector elements are calculated by elementwise multiplication of the transformed probability density vectors.

8. The method as claimed in claim 7, characterized in that the sum of the vector lengths of the probability density vectors of the independent risk factors is calculated by an FFT length optimization module (3), in that the FFT length optimization module (3) determines the value of the smallest power of two which is greater than the calculated sum, and in that the vector length of the probability density vectors of the independent risk factors is increased by the FFT length optimization module (3) to this value of the power of two, additional vector elements with the value zero being added.

9. The method as claimed in one of claims 7 or 8, characterized in that the probability density function proportional to the probability density function of the overall risk is scaled by a scaling module (7) with the aid of a value which is based on the equidistance with which the probability density vectors were determined by sampling from the probability density functions of the independent risk factors.

10. A computer program product comprising: a computer-readable medium in which there are contained computer program coding means for controlling a computer such that the computer executes all the steps of the method in accordance with one of claims 6 to 9.
